(19) United States
(12) Patent Application Publication
(10) Pub. No.: US 2007/0052655 A1
(43) Pub. Date: Mar. 8, 2007

(54) Display device

(76) Inventors: Toshifumi Ozaki, Koganei (JP); Masahisa Tsukahara, Fujisawa (JP)

Correspondence Address: MILBANK, TWEED, HADLEY & MCCLOY, 1 CHASE MANHATTAN PLAZA, NEW YORK, NY, 10005-1413, US

(21) Appl. No.: 11/505,742

(22) Filed: Aug. 17, 2006

(30) Foreign Application Priority Data
Sep. 8, 2005 (JP) 2005-261258

(51) Int. Cl. G09G 3/36

(52) U.S. Cl. 345/99

(57) ABSTRACT

In a display device which includes a scanning circuit, an ON resistance of a non-selection switch of the scanning circuit is set larger than an ON resistance of a selection switch. By setting the ON resistance of the non-selection switch of the scanning circuit larger than the ON resistance of the selection switch, an element size of the non selection switch can be made small and hence, a chip size of a scanning driver which is formed of a semiconductor integrated circuit constituting a scanning circuit can be made small without adversely influencing the display characteristics of the display device.

### BACKGROUND OF THE INVENTION

1. Field of the Invention

The present invention relates to a display device which uses a cold-cathode electron emission element such as a surface-conductive-type electron emission element, a field-emission-type electron emission element or the like, and more particularly a metal/insulation film/metal (MIM) type electron emission element.

2. Description of the Related Art

As drive circuits for driving a cold-cathode electron emission element, there have been known a CMOS output buffer which is constituted of a P-channel MOSFET and an N-channel MOSFET (see FIG. 19 of JP-A-2004-86130) (patent document 1) and an output buffer which is constituted of a PNP transistor and an NPN transistor (see FIG. 20 of patent document 1).

### SUMMARY OF THE INVENTION

In the display device which uses the cold-cathode electron emission element, due to a capacitance attributed to wiring, there arise drawbacks such as a rounding of an output waveform in a drive circuit, the reduction of an effective light emitting time, an erroneous emission of light, a non-uniform in-plane brightness.

To prevent these drawbacks, it is necessary to decrease an output resistance of the drive circuit together with the resistance of wiring. However, as described in paragraphs [0011] to [0013] of the above-mentioned patent document 1, there arises a drawback that a chip size of a semiconductor integrated circuit which constitutes the drive circuit is increased and hence, a chip cost is pushed up. Particularly, in the display device which uses an MIM-type electron emission element, an insulation film having a thickness of approximately 10 nm is sandwiched by an upper electrode and a lower electrode and hence, a capacitive value of the wiring is large and hence, the above-mentioned drawback becomes outstanding.

To overcome this drawback, inventors of the present invention have studied a driver output circuit. First of all, an emission current of the electron emission element is changed exponentially with respect to a voltage. Further, in general, a charge/discharge curve of capacitance is changed exponentially with respect to time and hence, an initial voltage change takes place sharply. In view of the above, when the emission current rises, the emission current is increased more gently than the voltage, while when the emission current falls, the emission current is decreased more sharply than the voltage.

Accordingly, even when the voltage change when the emission current falls is set gentler than the voltage change when the emission current rises, the influence of the voltage change to the brightness becomes extremely small.

The present invention is made by making use of the above-mentioned characteristics of the electron emission element, wherein by setting an ON resistance of a non-selection switch in a scanning circuit larger than an ON resistance of a selection switch in the scanning circuit, an element size of the non-selection switch can be made small thus decreasing a chip size of a scanning driver which is formed of a semiconductor integrated circuit constituting a scanning circuit without adversely influencing the display characteristics.

Further, according to the present invention, by setting a resistance of an output circuit when a voltage of a modulation circuit is changed from a white level voltage to a black level voltage larger than the resistance of the output circuit when the voltage of the modulation circuit is changed from the black level voltage to the white level voltage, an element size of a circuit for changing a voltage in an output circuit to a black level voltage from a white level voltage can be decreased and hence, a chip size of a data driver which is formed of a semiconductor integrated circuit constituting the modulation circuit can be decreased.

Further, according to the present invention, in view of the characteristics of a transistor that an ON resistance of a bipolar transistor is smaller than an ON resistance of a MOSFET, by forming the selection switch which requires a low ON resistance using the bipolar transistor, an element size can be decreased and hence, a chip size of the scanning driver can be decreased. Here, when the non-selection switch which may have the high ON resistance is formed of an MOSFET which is used in other portion of the scanning driver in the same manner, the increase of the number of steps can be made extremely small.

In the same manner, by constituting only the output circuit for changing the voltage to the white-level voltage from the black-level voltage, it is possible to decrease the element size while suppressing the increase of the number of steps to a minimum.

Further, according to the present invention, by arranging the bipolar transistor which constitutes the output circuit closer to an output than the MOSFET, even when a high voltage is generated on display panel wiring due to an abnormal discharge phenomenon, a junction between a collector diffusion layer and a substrate of the bipolar transistor is made in the forward direction and hence, an electric current flows in the substrate whereby the elevation of the voltage of the MOSFET part is decreased. As a result, there is no possibility that a gate insulation film of the MOSFET is broken.

According to the present invention, since the chip size of the semiconductor integrated circuit which constitutes the drive circuit can be decreased, it is possible to lower a chip unit cost.

The display device of the present invention is substantially characterized by following means.

(1) A display device which includes a display panel having a back plate on which a plurality of row lines, a plurality of column lines and a plurality of electron emission elements are formed and a face plate to which an anode voltage is applied, a scanning circuit which selects the row lines, and a modulation circuit which applies a modulation voltage to the column lines, wherein the scanning circuit includes a non-selection switch which is provided between a scanning circuit output point and a power source line and turns on/off a non-selection voltage and a selection switch which is provided between a scanning circuit output point and a power source line and turns on/off a selection voltage, and an ON resistance of the non-selection switch is set larger than an ON resistance of the selection switch. Further, the selection switch is formed of a bipolar transistor and the non-selection switch is formed of a MOSFET. Further, the bipolar transistor is arranged closer to an output than the MOSFET. Still further, the electron emission elements are formed of an MIM-type electron emission element.

(2) A display device which includes a display panel having a back plate on which a plurality of row lines, a plurality of column lines and a plurality of electron emission elements are formed and a face plate to which an anode voltage is applied, a scanning circuit which selects the row lines, and a modulation circuit which applies a modulation voltage to the column lines, wherein the modulation circuit includes an output circuit, and an output resistance of the output circuit when a voltage is changed from a white level voltage to a black level voltage is set larger than the output resistance of the output circuit when the voltage is changed from the black level voltage to the white level voltage. Further, the output circuit when the voltage is changed from the black level voltage to the white level voltage is formed of a bipolar transistor and the output circuit when the voltage is changed from the white level voltage to the black level voltage is formed of a MOSFET. Further, the bipolar transistor is arranged closer to an output than the MOSFET. Still further, at least one of the output circuit when the voltage is changed from the white level voltage to the black level voltage and the output circuit when the voltage is changed from the black level voltage to the white level voltage is formed of a bipolar transistor. Still further, the electron emission elements are formed of an MIM-type electron emission element.

(3) A display device which includes a display panel having a back plate on which a plurality of row lines, a plurality of column lines and a plurality of electron emission elements are formed and a face plate to which an anode voltage is applied, a scanning circuit which selects the row lines, and a modulation circuit which applies a modulation voltage to the column lines, wherein the scanning circuit includes a non-selection switch which is provided between a scanning circuit output point and a power source line and turns on/off a non-selection voltage and a selection switch which is provided between a scanning circuit output point and a power source line and turns on/off a selection voltage, and at least one of the non-selection switch and the selection switch is formed of a bipolar transistor.

(4) A display device which includes a display panel having a back plate on which a plurality of row lines, a plurality of column lines and a plurality of electron emission elements are formed and a face plate to which an anode voltage is applied, a scanning circuit which selects the row lines, and a modulation circuit which applies a modulation voltage to the column lines, wherein the modulation circuit includes an output circuit, and at least one of the output circuit when a voltage is changed from a black level voltage to a white level voltage and the output circuit when the voltage is changed from the white level voltage to the black level voltage is formed of a bipolar transistor, and another output circuit is formed of a MOSFET.

### BRIEF DESCRIPTION OF THE DRAWINGS

FIG. 1 is a block diagram showing the whole circuit constitution of a display device according to the present invention;

FIG. 2 is a constitutional view of a data driver which is formed of a semiconductor integrated circuit constituting a modulation circuit 5 shown in FIG. 1;

FIG. 3 is a constitutional view of a scanning driver formed of a semiconductor integrated circuit which constitutes scanning circuits 6-1, 6-2 shown in FIG. 1;

FIG. 4 is a view showing an output circuit 31 in the inside of the scanning driver shown in FIG. 3 in detail;

FIG. 5 is a remotest end output voltage waveform chart of the data driver and the scanning driver during one horizontal scanning period of an embodiment 1;

FIG. 6 is a current-voltage characteristic diagram of an MIM-type electron emission element;

FIG. 7 is a remotest end output voltage waveform chart of the data driver and the scanning driver during one horizontal scanning period of an embodiment 2;

FIG. 8 is a view showing the output circuit 31 in detail in the inside of the scanning driver shown in FIG. 3 of an embodiment 3;

FIG. 9A is a plan view of a unit 31-2 shown in FIG. 8, and FIG. 9B is a cross-sectional view of a portion taken along a chain line A-A′-B-B′ in the plan view of FIG. 9A;

FIG. 10 is a remotest end output voltage waveform chart of the data driver and the scanning driver during one horizontal scanning period of an embodiment 4;

FIG. 11 is a remotest end output voltage waveform chart of the data driver and the scanning driver during one horizontal scanning period of an embodiment 5; and

FIG. 12 is a block diagram showing the whole circuit constitution of a display device of an embodiment 6.

### DESCRIPTION OF THE PREFERRED EMBODIMENTS

Hereinafter, embodiments of the present invention are explained in conjunction with attached drawings.

[Embodiment 1]

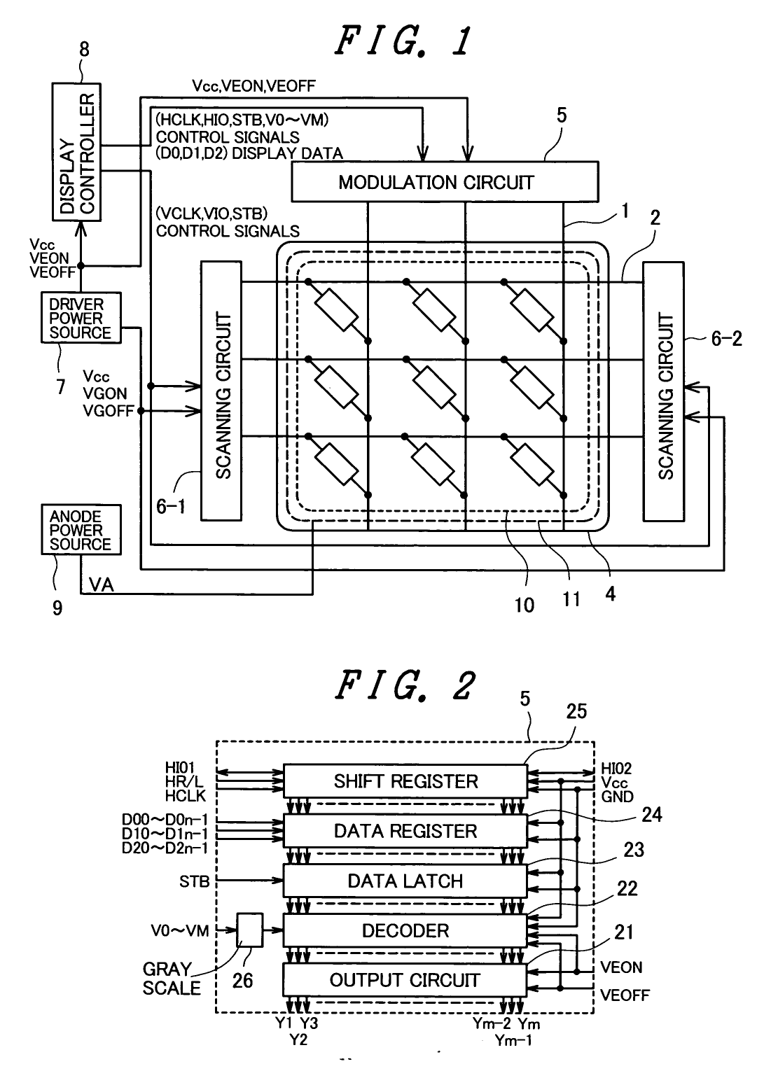

FIG. 1 is a block diagram showing the whole circuit constitution of a display device which uses MIM-type electron emission elements according to the present invention. On a back plate which constitutes a display panel 4, the MIM-type electron emission elements 3, column lines 1 which are connected with lower electrodes of the MIM-type electron emission elements 3, and row lines 2 which are connected with upper electrodes of the MIM-type electron emission elements 3 are formed. A face plate which constitutes the display panel 4 includes a phosphor film 10, and a metal back 11 which is formed to cover the phosphor film 10 on a surface thereof which faces the back plate. Further, the display panel 4 includes an air discharge port formed in a side wall (not shown in the drawing) which is formed in a periphery of an image display region to evacuate the inside of the panel into a vacuum. The phosphor film 10 is constituted of three primary colors of red, green and blue which are separately colored for every column of the MIM type electron emission elements 3.

Numeral 5 indicates a modulation circuit which outputs a modulation signal to the column lines, and numerals 6-1, 6-2 indicate scanning circuits which are arranged on both sides of the display panel 4 and perform the row selection.

A driver power source 7 supplies a logic circuit voltage Vcc, a selection voltage VGON and a non-selection voltage VGOFF to the scanning circuits 6-1, 6-2. Further, the driver power source 7 supplies a logic circuit voltage Vcc, a light emitting voltage VEON and a non-light-emitting voltage VEOFF to the modulation circuit 5 and the display controller 8.

The display controller 8 outputs a vertical clock VCLK, a start pulse VIO and an output changeover signal STB which constitute control signals to the scanning circuits 6-1, 6-2. Further, the display controller 8 outputs a horizontal clock HCLK, a start pulse HIO, an output changeover signal STB, modulation-circuit-use reference voltages VO to VM which constitute control signals, and the 3-output display data D0, D1, D2 of n bits corresponding to red, green, blue which constitute display data to the modulation circuit 5. With respect to these control signals, all signals except for the modulation-circuit-use reference voltages VO to VM have amplitude of the logic circuit voltage Vcc.

Further, an anode power source 9 supplies an anode voltage VA for allowing a phosphor to emit light to the metal back 11.

FIG. 2 is a constitutional view of a data driver which is formed of a semiconductor integrated circuit which constitutes a modulation circuit 5 shown in FIG. 1. The modulation circuit 5 is formed by connecting the data drivers in series.

In FIG. 2, numeral 25 indicates a shift register which generates a latch signal for fetching the display data, numeral 24 indicates a data register which sequentially fetches 3-output display data D00 to D0n−1, D10 to D1n−1, D20 to D2n−1 of n bits corresponding to red, green and blue which are simultaneously inputted from the display controller, numeral 23 indicates a data latch which fetches the display data of a data register in synchronism with an output changeover signal STB, numeral 26 indicates a gray scale voltage generating part which generates gray scale voltages of n-powers of 2 from reference voltages VO to VM for the modulation circuit which the display controller 8 outputs based on resistance division, numeral 22 indicates a decoder which selects a voltage from the gray scale voltages of n-power of 2 corresponding to display data of n bits which the data latch outputs, and numeral 21 indicates an output circuit which is constituted of voltage followers for outputting decoder output voltages as output voltages Yl to Ym to respective column lines 1 of the display panel 4.

Here, symbol HR/L indicates a signal for determining the shift direction of the shift register and is fixed to the logic circuit voltage Vcc or a ground voltage GND.

First of all, the modulation-circuit-use reference voltages VO to VM are formed of a voltage obtained by equally dividing a voltage range between a non-light-emission voltage VEOFF and a maximum light emission voltage VEON in M, wherein divided resistance values of resistances which form a gray scale voltage generating part 26 are all equal and a linear relationship is established between gray scales and output voltages.

First of all, when one horizontal scanning period is started, the start pulse HIO is inputted as the HIO1 (or HIO2) signal of the first data driver and is shifted in synchronism with the horizontal clock HCLK in the inside of the shift register 25, while when the latch signal is outputted, the 3-output display data of n bits is simultaneously and sequentially fetched into the data register 24.

When the fetching of display data into the data register 24 of the first data driver is finished, the voltage of the HIO2 (or HIO1) becomes the logic circuit voltage Vcc and is inputted to the HIO1 (or HIO2) of the second data driver, and the fetching of the display data to the second data driver is started.

When the fetching of all display data into the data register 24 is finished in this manner, immediately before one horizontal scanning period is finished, all display data is fetched into the data latch 23 from the data register 24 in synchronism with the rise of an output changeover signal STB.

The fetched data is converted into the gray scale voltages respectively by the decoder 22, and the gray scale voltages are outputted to the respective column lines by the output circuit 21.

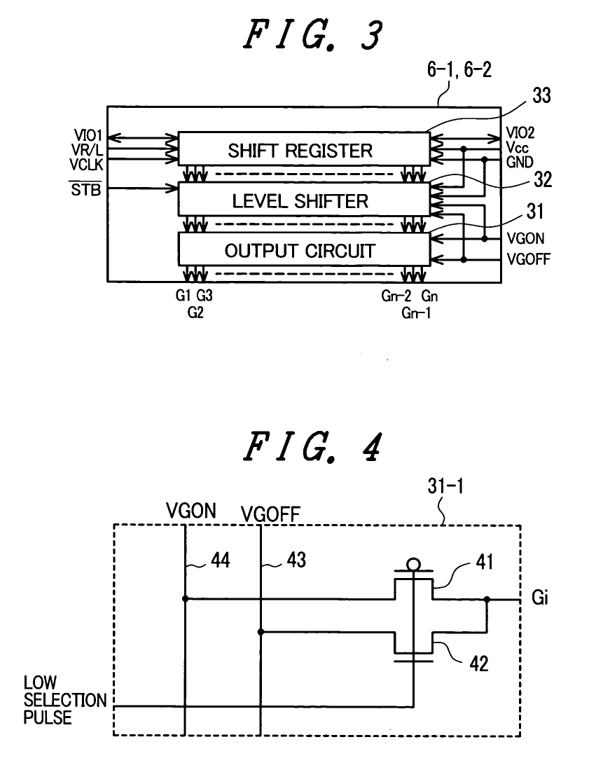

FIG. 3 is a constitutional view of the scanning driver which is formed of a semiconductor integrated circuit which constitutes scanning circuits 6-1, 6-2 shown in FIG. 1. The scanning circuits 6-1, 6-2 are formed by connecting the respective scanning drivers in series.

In FIG. 3, numeral 33 indicates a shift register which generates a selection signal for sequentially changing over the selected rows for every one horizontal scanning period, numeral 32 indicates a level shifter which converts a shift resistor output from a level of a logic circuit voltage Vcc-GND to a level of selection voltage VGON-non-selection voltage VGOFF, and numeral 31 indicates an output circuit for outputting the selection voltage VGON or the non-selection voltage VGOFF as the output voltages Gl to Gn to the respective row lines 2 of the display panel 4 in response to the level-shifted shift resistor output.

Here, symbol VR/L indicates a signal for determining the shift direction of the shift register and is fixed to the logic circuit voltage Vcc or a ground voltage GND.

First of all, when one vertical scanning period is started, the start pulse VIO is inputted as the VIO1 (or VIO2) signal of the first scanning driver and is shifted in synchronism with the vertical clock VCLK for every one horizontal scanning period in the inside of the shift register 33, and the selection signal is sequentially outputted.

A logic product of the outputted selection signal and the inversion signal of the output changeover signal STB has a level thereof shifted to a level of selection voltage VGON-non-selection voltage VGOFF by the level shifter 32 and is outputted to the selected row lines of the display panel 4 as the selection voltage VGON. On the other hand, the non-selection voltage VGOFF is outputted to the non-selected row lines of the display panel 4.

When the shift inside the first scanning driver is finished, the voltage of the VIO2 (or VIO1) becomes the logic circuit voltage Vcc and is inputted to the VIO1 (or VIO2) of the second scanning driver, and the shift in the inside of the second scanning driver is started. In this manner, all rows are sequentially selected.

FIG. 4 is a view showing the output circuit 31 in the inside of the scanning driver shown in FIG. 3 in detail, and numeral 31-1 indicates a unit of the output circuit 31 which is mounted for every row.

In FIG. 4, numeral 42 indicates an nMOS non-selection switch which turns on/off a non-selection voltage VGOFF, and numeral 41 indicates a pMOS selection switch which turns on/off a selection voltage VGON. Further, numeral 43 indicates a power source line which supplies the non-selection voltage VGOFF to the nMOS non-selection switch 42, and numeral 44 indicates a power source line which supplies the selection voltage VGON to the PMOS selection switch 41.

Here, an ON resistance of the nMOS non-selection switch 42 is large, that is, approximately twice as large as an ON resistance of the pMOS selection switch 41.

First of all, when the output changeover signal STB falls, an output of a row selection pulse of the selected row is lowered and hence, the nMOS non-selection switch 42 of the selected row is turned off and the pMOS selection switch 41 is turned on whereby an output voltage Gi of the output circuit is elevated to the selection voltage VGON from the non-selection voltage VGOFF.

Then, when the output changeover signal STB rises, the output of the row selection pulse of the selected row is increased and hence, the pMOS selection switch 41 of the selected row is turned off and the nMOS non-selection switch 42 is turned on whereby an output voltage Gi of the output circuit is lowered to the non-selection voltage VGOFF from the selection voltage VGON.

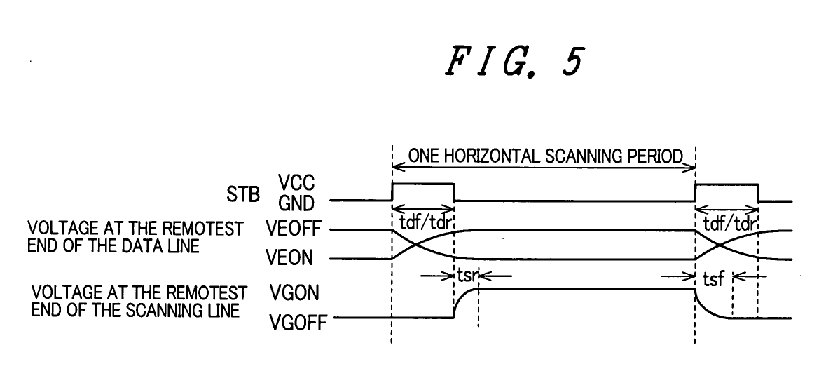

FIG. 5 is a waveform chart of remotest end output voltages of the data driver and the scanning driver within one horizontal scanning period.

First of all, in synchronism with the rise of the output changeover signal STB, the data driver output is changed over. Next, with a delay attributed to either greater one out of a data driver output rise time tdr and a data driver output fall time tdf which are determined based on the resistance and the capacitance of the row line and the output impedance of the data driver, in synchronism with the fall of the output changeover signal STB, the selection row scanning driver output is changed from the non-selection voltage VGOFF to the selection voltage VGON.

At a point of time that one horizontal scanning period is finished, the selection row scanning driver output is changed from the selection voltage VGON to the non-selection voltage VGOFF and, at the same time, the data driver output is changed over.

In this embodiment, since the light emission time is determined based on the output time of the scanning driver, the light emitting intensity is not influenced by data of preceding and succeeding rows.

That is, after the data driver output is changed over, when only greater one out of a data driver output rise time tdr and a data driver output fall time tdf lapses, the output voltage becomes stable and, thereafter, the selection row scanning driver output is changed from the non-selection voltage VGOFF to the selection voltage VGON. As a result, the light emitting intensity is not influenced by data of preceding and succeeding rows. Further, in synchronism with the changeover of the data driver output, the selection row scanning driver output is changed from the selection voltage VGON to the non-selection voltage VGOFF and hence, the light emitting intensity is not influenced by data of succeeding row.

Further, the scanning driver output fall time tsf which is determined based on the resistance and the capacitance of the row line and the ON resistance of the scanning driver becomes longer than the data driver rise time tsr.

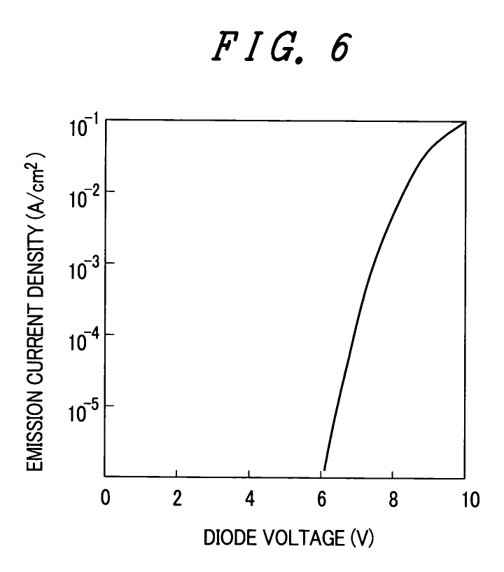

Here, an emission current of the MIM-type electron emission element is, as shown in FIG. 6, changed exponentially with respect to the voltage. Further, in general, a charge/discharge curve of capacitance is changed exponentially with respect to time and hence, an initial voltage change takes place sharply. In view of the above, when the scanning driver output voltage rises, the current is increased more gently than the voltage, while when the scanning driver output voltage falls, the current is decreased faster than the voltage. Accordingly, even when the scanning driver output fall time tsf is set longer than the scanning driver output rise time tsr, the influence of the voltage change to the brightness becomes extremely small.

The present invention is made by making use of the above-mentioned characteristics of the electron emission elements, wherein the ON resistance of the nMOS non-selection switch which constitutes the scanning driver output circuit is set larger than the ON resistance of the pMOS selection switch. As a result, an element size of the nMOS non-selection switch can be made small thus decreasing a chip size of the scanning driver.

[Embodiment 2]

In the above-mentioned embodiment 1, the row line 2 is connected to the upper electrode of the MIM-type electron emission element 3 and the column line 1 is connected to the lower electrode of the MIM-type electron emission element 3. In this embodiment, to the contrary, the column line 1 is connected to the upper electrode of the MIM-type electron emission element 3 and the row line 2 is connected to the lower electrode of the MIM-type electron emission element 3.

Due to such a constitution, with respect to the output circuit in the inside of the scanning driver, the pMOS selection switch 41 in the embodiment 1 is used as the pMOS non-selection switch and the non-selection voltage VGOFF is turned on/off by the switch, while the nMOS non-selection switch 42 in the embodiment 1 is used as the nMOS selection switch and the selection voltage VGON is turned on/off by the switch.

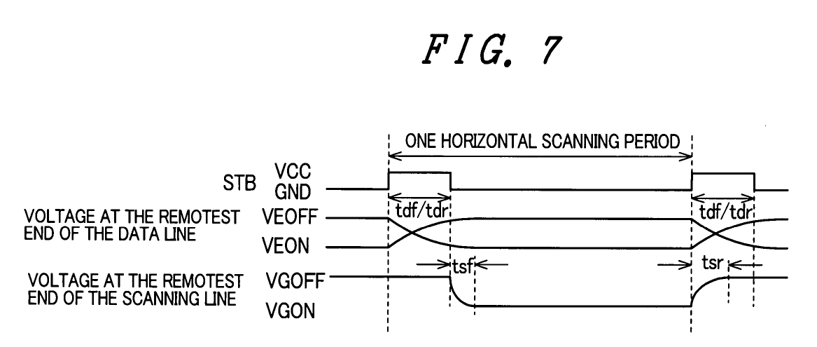

FIG. 7 is a waveform chart of remotest end output voltages of the data driver and the scanning driver within one horizontal scanning period, wherein the connection of the upper and lower electrodes with the column and row lines is opposite to the corresponding connection in the embodiment 1 and hence, the polarity of the pulse shown in FIG. 7 becomes opposite to the polarity of the pulse shown in FIG. 5.

Also in this embodiment, in the same manner as the embodiment 1, since the light emission time is determined based on the output time of the scanning driver, the light emitting intensity is not influenced by data of preceding and succeeding rows.

In this embodiment, the scanning driver output rise time tsr which is determined based on the resistance and the capacitance of the row line and the ON resistance of the scanning driver is set longer than the scanning driver fall time tsf, and the ON resistance of the PMOS non-selection switch which constitutes the scanning driver output circuit is set larger than the ON resistance of the nMOS selection switch.

As a result, an element size of the pMOS non-selection switch can be made small and hence, a chip size of the scanning driver can be made small. Here, since the mobility of PMOS is approximately ½ of the nMOS, the size of the pMOS becomes approximately twice as large as the size of the nMOS to obtain the same ON resistance.

Accordingly, in this embodiment, it is possible to decrease the element size of the pMOS and hence, it is possible to make the chip size of the scanning driver smaller than the chip size of the scanning driver of the embodiment 1.

[Embodiment 3]

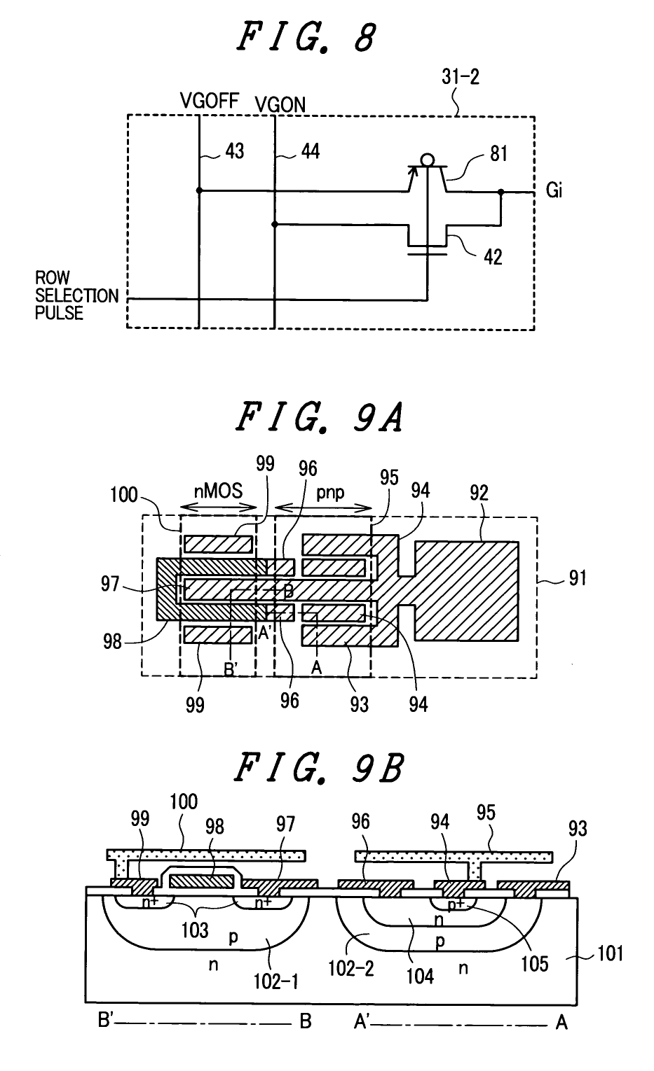

FIG. 8 is a view showing the output circuit 31 in the inside of the scanning driver shown in FIG. 3 in detail. In this embodiment, the PMOS selection switch 41 of the embodiment 1 shown in FIG. 4 is replaced with a pnp transistor 81.

In FIG. 8, numeral 31-2 indicates a unit of the output circuit 31 which is provided for every line. Numeral 42 indicates an nMOS non-selection switch which turns on/off the non-selection voltage VGOFF, and numeral 81 indicates a pnp transistor selection switch which turns on/off the selection voltage VGON. Further, numeral 43 indicates a power source line which supplies the non-selection voltage VGOFF to the nMOS non-selection switch 42, and numeral 44 indicates a power source line which supplies the selection voltage VGON to the pnp transistor selection switch 81.

Here, an ON resistance of the nMOS non-selection switch 42 is larger than an ON resistance of the pnp transistor selection switch 81.

FIG. 9A is a plan view of a unit 31-2 of an output circuit 31 which is provided for every line shown in FIG. 8, and FIG. 9B is a cross-sectional view of a portion taken along a chain line A-A′, B-B′ in the plan view of FIG. 9A.

In FIG. 9A and FIG. 9B, a hatched region is formed of a first-layer aluminum line, a region surrounded by a dotted line is formed of a second-layer aluminum line and a matted region is formed of a gate electrode made of polysilicon or the like.

In FIG. 9A and FIG. 9B, numeral 91 indicates a unit region of an output circuit in the inside of the scanning driver indicated by numeral 31-2 in FIG. 8, numeral 92 indicates a bonding bad portion line for connection with the row line, numeral 93 indicates a collector portion line of the pnp transistor 81, numeral 94 indicates an emitter portion line of the pnp transistor 81, numeral 95 indicates a power source line which is connected with the emitter portion line 94 for supplying the selection voltage VGON indicated by numeral 44 in FIG. 8, numeral 96 indicates a base portion line of the pnp transistor 81, numeral 97 indicates a drain portion line of the n-channel MOSFET, numeral 98 indicates a gate electrode of the n-channel MOSFET which is connected with the base portion line 96, numeral 99 indicates a source portion line of the n-channel MOSFET, and numeral 100 indicates a power source line which is connected to the source portion line 99 and supplies the non-selection voltage VGOFF indicated by numeral 43 in FIG. 8.

Further, numeral 101 indicates an n substrate, numeral 102-1 indicates a p-type well, numeral 103 indicates a n-type source/drain diffusion layer of the n-channel MOSFET, numeral 102-2 indicates a pnp transistor collector diffusion layer which is formed on the same layer as the p-type well 102-1, numeral 104 indicates a pnp transistor base diffusion layer, numeral 105 indicates an emitter diffusion layer which is formed on the same layer as the p-type source/drain diffusion layer of the p-channel MOSFET (not shown in the drawing).

In this embodiment, the selection switch 81 which requires the low ON resistance is formed of a bipolar transistor. The ON resistance of the bipolar transistor is smaller than an ON resistance of the MOSFET having the same size and hence, the element size of the pnp transistor selection switch 81 can be made small thus making the chip size of the scanning driver small.

Further, by forming the nMOS non-selection switch 42 which may have the high ON resistance using a MOSFET substantially equal to the MOSFET used in other portions of the scanning driver, it is possible to minimize the increase of the number of steps. Here, in the example shown in FIG. 9B, only the step for forming the base diffusion layer 104 of the bipolar transistor is increased.

Further, by arranging the bipolar transistor which constitutes the selection switch closer to the bonding pad portion line 92 than the MOSFET which constitutes the non-selection switch, it is possible to enhance the dielectric strength.

In general, in a display device which uses electron emission elements, since a high voltage is applied to an anode, there exists a possibility that a high voltage is applied to the line attributed to an abnormal discharge phenomenon which occurs in the inside of the display panel.

However, in this embodiment, even when the high voltage is applied to the bonding pad portion line 92, a junction between the collector diffusion layer 102-2 of the bipolar transistor which constitutes the selection switch and the substrate 101 is made in the forward direction and hence, an electric current flows in the substrate 101.

In this manner, the selection switch can ensure a large area even when the selection switch is constituted of the bipolar transistor and hence, the elevation of voltage of the drain portion line 97 of the non-selection switch MOSFET can be reduced. As a result, there arises no possibility that the gate insulation film of the MOSFET is broken.

Here, it may be possible to acquire the further protection of the gate insulation film of the MOSFET by providing a well-known protection circuit which is formed of a diode and a resistance or a well-known protection circuit which is formed of a diode, a resistance and a MOSFET to the collector portion line 93 and the drain portion line 97.

[Embodiment 4]

In this embodiment, the light emission time is determined based on the output time of the data driver. In the same manner as the embodiment 1, a column line 1 is connected with a lower electrode of an MIM-type electron emission element 3, while a row line 2 is connected with an upper electrode of the MIM-type electron emission element 3.

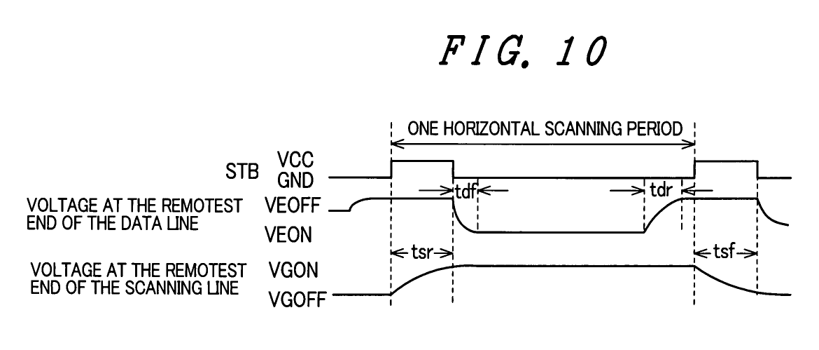

FIG. 10 is a remotest end output voltage waveform chart of the data driver and the scanning driver during one horizontal scanning period.

In FIG. 10, in synchronism with the rise of an output changeover signal STB, an output of a selection row scanning driver rises to a selection voltage VGON from a non-selection voltage VGOFF.

Next, with a delay by a scanning driver output rise time tsr which is determined based on the resistance and the capacitance of the row line and the ON resistance of the scanning driver, in synchronism with the fall of the output changeover signal STB, the output of the data driver falls from a black level voltage VEOFF to a white level voltage which has a value between the black level voltage VEOFF and a VEON corresponding to a light emission quantity.

At a point of time that one horizontal scanning period is finished, the output of the data driver rises from the white level voltage to the black level voltage VEOFF and, thereafter, the output of the selection row scanning driver falls from the selection voltage VGON to the non-selection voltage VGOFF.

In this embodiment, the light emission time is determined based on the output time of the data driver.

Further, by setting the rise time tdr of the output of the data driver which is determined based on the resistance and the capacitance of the line and the output resistance of the data driver longer than the fall time tdf and by setting the output resistance at the time of rise of the voltage from the white level voltage to the black level voltage in the output circuit of the data driver larger than the output resistance at the time of fall of the voltage from the black level voltage to the white level voltage in the output circuit of the data driver, it is possible to make the element size for performing the rise of the output circuit of the data driver small thus realizing the reduction of the chip size of the data driver.

[Embodiment 5]

Also in this embodiment, the light emission time is determined based on the output time of the data driver. In the same manner as the embodiment 2, a column line 1 is connected with an upper electrode of an MIM-type electron emission element 3, while a row line 2 is connected with a lower electrode of the MIM-type electron emission element 3.

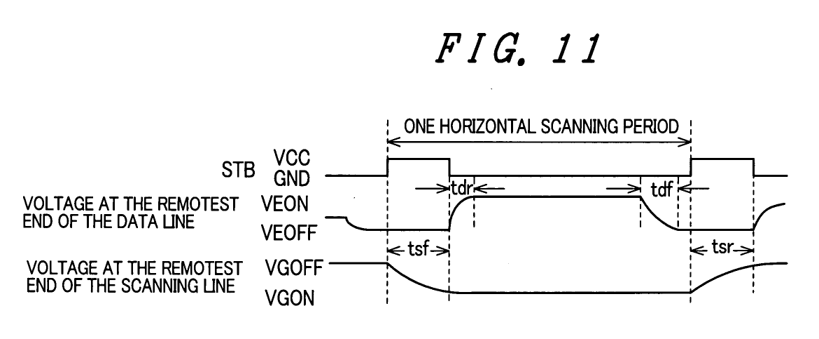

FIG. 11 is a remotest end output voltage waveform chart of the data driver and the scanning driver during one horizontal scanning period.

In FIG. 11, in synchronism with the rise of an output changeover signal STB, an output of a selection row scanning driver falls to a selection voltage VGON from a non-selection voltage VGOFF.

Next, with a delay by a scanning driver output fall time tsf which is determined based on the resistance and the capacitance of the row line and the ON resistance of the scanning driver, in synchronism with the fall of the output changeover signal STB, the output of the data driver rises from a black level voltage VEOFF to a white level voltage which has a value between the black level voltage VEOFF and a VEON to a white level voltage corresponding to a light emission quantity.

At a point of time that one horizontal scanning period is finished, the output of the data driver falls from the white level voltage to the black level voltage VEOFF and, thereafter, the output of the selection row scanning driver rises from the selection voltage VGON to the non-selection voltage VGOFF.

In this embodiment, the light emission time is determined based on the output time of the data driver.

Further, by setting the fall time tdf of the output of the data driver which is determined based on the resistance and the capacitance of the line and the output resistance of the data driver longer than the rise time tdr and by setting the output resistance at the time of fall of the voltage from the white level voltage to the black level voltage in the output circuit of the data driver larger than the output resistance at the time of rise of the voltage from the black level voltage to the white level voltage in the output circuit of the data driver, it is possible to make the element size for performing the rise of the output circuit of the data driver small thus realizing the reduction of the chip size of the data driver.

[Embodiment 6]

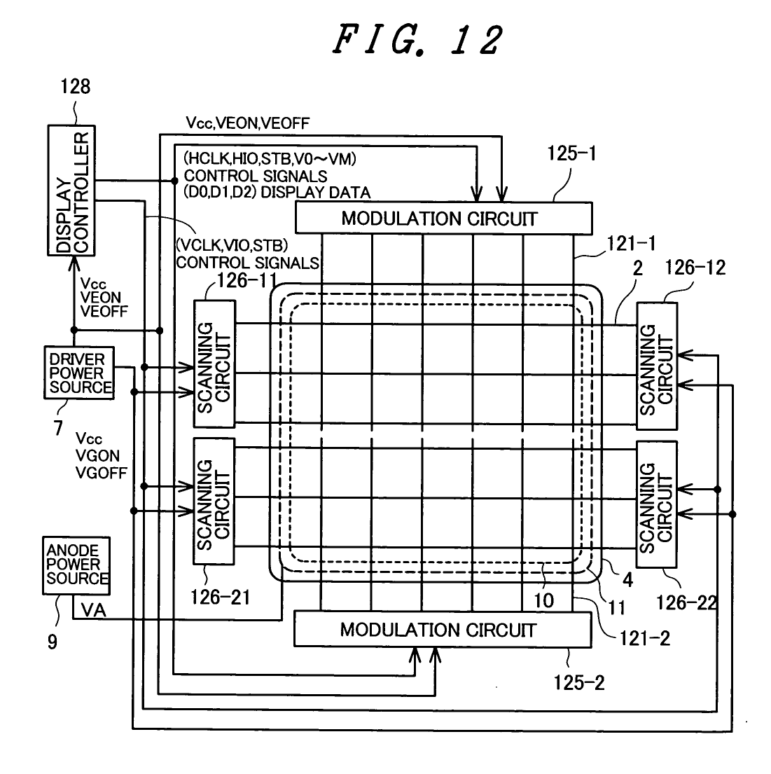

FIG. 12 is a block diagram showing the whole circuit constitution of this embodiment, wherein the screen is divided into upper and lower blocks and images are simultaneously displayed on the upper and lower blocks. Here, numerals 2, 4, 7, 9, 10, 11 indicate parts identical with the parts shown in FIG. 1.

In FIG. 12, numerals 121-1, 121-2 indicate column lines which are divided at the center of the display panel 4, numerals 125-1, 125-2 indicate modulation circuits which output modulation signals to the upper and lower column lines respectively, numerals 126-11, 126-12 indicate scanning circuits which are arranged on both sides of the display panel 4 and perform the row selection of the upper portion of the screen, and numerals 126-21, 126-22 indicate scanning circuits which are arranged on both sides of the display panel 4 and perform the row selection of the lower portion of the screen.

The driver power source 7 supplies a logic circuit voltage Vcc, a selection voltage VGON and a non-selection voltage VGOFF to the scanning circuits 126-11, 126-12, 126-21, 126-22, and the driver power source 7 supplies a maximum light emitting voltage VEON, a non-light emitting voltage VEOFF, and a logic circuit voltage Vcc to the modulation circuits 125-1, 125-2 and the display controller 128.

The display controller 128 outputs a vertical clock VCLK, a start pulse VIO, a selection period signal VGO to the scanning circuits 126-11, 126-12, 126-21, 126-22, and outputs a horizontal clock HCLK, a start pulse HIO, an output changeover signal STB, a reference voltages VO to VM, the 3-output display data D0, D1, D2 of n bits corresponding to red, green, blue, to the modulation circuits 125-1, 125-2.

Among these signals, all signals except for the reference voltages VO to VM have amplitude of the logic circuit voltage Vcc. Here, corresponding to red, green, blue, 3-output display data D0, D1, D2 of n bits differ from each other between the modulation circuits 125-1, 125-2.

The constitution and the manner of operation of the modulation circuits 125-1, 125-2 and the scanning circuits 126-11, 126-12, 126-21, 126-22 are equal to those constitution and manner of operation of the embodiment 1.

The display controller 128 outputs the 3-output display data D0, D1, D2 of n bits simultaneously to the respective modulation circuits 125-1, 125-2.

A frame memory is mounted in another portion of the display controller 128, the display controller 128 receives the video signals from the outside of the display device and outputs the 3-output display data D0, D1, D2 of n bits corresponding to red, green, blue corresponding to the upper and lower blocks to the modulation circuits 125-1, 125-2, and the control signals are outputted to the scanning circuits 126-11, 126-12, 126-21, 126-22.

In this embodiment, the screen is divided into the upper and lower blocks and the image is simultaneously displayed on the upper and lower blocks. As a result, the display time for one row can be increased twice compared to the related art and hence, assuming that the brightness is equal, the current which flows in the row line can be halved. Further, the column lines are divided and hence, the drive capacities of the modulation circuits 125-1, 125-2 can be halved, whereby the power which is consumed by the modulation circuits 125-1, 125-2 can be halved. Here, in this embodiment, although the scanning circuit is arranged at both sides, the scanning circuit may be arranged on one side.

Here, according to the present invention, by using the npn transistor in the circuit for falling the voltage from the black level voltage to the white level voltage in FIG. 4 and the pnp transistor in the circuit for falling the voltage from the black level voltage to the white level voltage in FIG. 5 in the selection switch 41 of the embodiment 2, it is possible to obtain advantageous effects substantially equal to the advantageous effects of the embodiment 3.

What is claimed is:

1. A display device comprising:
a display panel having a back plate on which a plurality of row lines, a plurality of column lines and a plurality of electron emission elements are formed and a face plate to which an anode voltage is applied;
a scanning circuit which selects the row lines; and
a modulation circuit which applies a modulation voltage to the column lines, wherein
the scanning circuit includes a non-selection switch which is provided between a scanning circuit output point and a power source line and turns on/off a non-selection voltage and a selection switch which is provided between a scanning circuit output point and a power source line and turns on/off a selection voltage, and
an ON resistance of the non-selection switch is set larger than an ON resistance of the selection switch.

2. A display device according to claim 1, wherein the selection switch is formed of a bipolar transistor and the non-selection switch is formed of a MOSFET.

3. A display device according to claim 2, wherein the bipolar transistor is arranged closer to an output than the MOSFET.

4. A display device according to claim 1, wherein the electron emission elements are formed of an MIM type electron emission element.

5. A display device which comprising:
a display panel having a back plate on which a plurality of row lines, a plurality of column lines and a plurality of electron emission elements are formed and a face plate to which an anode voltage is applied;
a scanning circuit which selects the row lines; and
a modulation circuit which applies a modulation voltage to the column lines, wherein
the modulation circuit includes an output circuit, and an output resistance of the output circuit when a voltage is changed from a white level voltage to a black level voltage is set larger than the output resistance of the output circuit when the voltage is changed from the black level voltage to the white level voltage.

6. A display device according to claim 5, wherein the output circuit when the voltage is changed from the black level voltage to the white level voltage is formed of a bipolar transistor and the output circuit when the voltage is changed from the white level voltage to the black level voltage is formed of a MOSFET.

7. A display device according to claim 6, wherein the bipolar transistor is arranged closer to an output than the MOSFET.

8. A display device according to claim 5, wherein the electron emission elements are formed of an MIM type electron emission element.

9. A display device comprising:
a display panel having a back plate on which a plurality of row lines, a plurality of column lines and a plurality of electron emission elements are formed and a face plate to which an anode voltage is applied;
a scanning circuit which selects the row lines; and
a modulation circuit which applies a modulation voltage to the column lines,
wherein the scanning circuit includes a non-selection switch which is provided between a scanning circuit output point and a power source line and turns on/off a non-selection voltage and a selection switch which is provided between a scanning circuit output point and a power source line and turns on/off a selection voltage, and
one of the non-selection switch and the selection switch is formed of a bipolar transistor and another switch is formed of a MOSFET.

10. A display device according to claim 9, wherein the bipolar transistor is arranged closer to an output than the MOSFET.

11. A display device comprising:
a display panel having a back plate on which a plurality of row lines, a plurality of column lines and a plurality of electron emission elements are formed and a face plate to which an anode voltage is applied;
a scanning circuit which selects the row lines; and
a modulation circuit which applies a modulation voltage to the column lines, wherein
the modulation circuit includes an output circuit, and at least one of the output circuit when a voltage is changed from a black level voltage to a white level voltage and the output circuit when the voltage is changed from the white level voltage to the black level voltage is formed of a bipolar transistor, and another output circuit is formed of a MOSFET.

12. A display device according to claim 11, wherein the bipolar transistor is arranged closer to an output than the MOSFET.
